(19) United States
(12) Patent Application Publication
(10) Pub. No.: US 2016/0050332 A1
(43) Pub. Date: Feb. 18, 2016

(54) IMAGE PROCESSING APPARATUS FOR CONTROLLING DYNAMIC RECONFIGURABLE APPARATUS, INFORMATION PROCESSING METHOD FOR IMAGE PROCESSING APPARATUS, AND STORAGE MEDIUM FOR STORING PROGRAM TO ACHIEVE INFORMATION PROCESSING METHOD

(71) Applicant: CANON KABUSHIKI KAISHA, Tokyo (JP)

(72) Inventor: Masanori Ichikawa, Tokyo (JP)

(21) Appl. No.: 14/819,994

(22) Filed: Aug. 6, 2015

(30) Foreign Application Priority Data
Aug. 18, 2014 (JP) 2014-166054

(51) Int. Cl. H04N 1/00

(52) U.S. Cl. CPC H04N 1/00888; H04N 1/00954; H04N 1/00962; H04N 2201/0094

(57) ABSTRACT

To reduce power consumption, an image processing apparatus comprises: an identifying unit configured to identify a logic circuit according to a job; a selecting unit configured to select configuration data corresponding to the logic circuit identified by the identifying unit; a first transferring unit configured to transfer the configuration data selected by the selecting unit to a dynamic reconfiguration unit; and a second transferring unit configured to, in a case where an image process related to the job in the dynamic reconfiguration unit to which the configuration data was transferred by the first transferring unit is ended, transfer configuration data of a logic circuit of a dummy process to the dynamic reconfiguration unit.

### BACKGROUND OF THE INVENTION

1. Field of the Invention

The present invention relates to an image processing apparatus for controlling a dynamic reconfigurable apparatus, an information processing method for the image processing apparatus, and a recording medium for storing a program to achieve the information processing method.

2. Description of the Related Art

A reconfigurable circuit such as a PLD (programmable logic device), an FPGA (field programmable gate array) or the like capable of changing its internal logic circuit configuration has been well known. Here, the reconfigurable circuit is equivalent to a circuit in which reconfiguration of its internal logic circuit configuration can be performed. In general, the PLD or the FPGA is achieved by writing logic circuit configuration information stored in a nonvolatile memory such as a ROM (read only memory) or the like into a configuration memory being an internal volatile memory when starting the circuit, and thus switching the function of the internal logic block based on the written logic circuit configuration information. Incidentally, since the information in the configuration memory is cleared when turning off a power supply, it is necessary to again perform the reconfiguration by writing the logic circuit configuration information into the configuration memory when turning on the power supply. Such a method of configuring the hardware resources once is called a static reconfiguration. On another front, a circuit capable of changing its internal logic circuit configuration during an operation has been developed, and a method of changing or configuring the logic circuit during the operation is called a dynamic reconfiguration.

incidentally, the FPGA includes a type capable of rewriting not the whole chip thereof but only a specific area thereof, and such a rewriting method is called a Partial reconfiguration. In particular, a method of performing the partial reconfiguration in a state that other running circuits are not stopped is called a dynamic partial reconfiguration.

In the dynamic partial reconfiguration, the whole of the configuration memory is not rewritten at the time of the dynamic reconfiguration, but only a part of the reconfiguration memory area is rewritten. Thus, the partial reconfiguration of the logic block in the FPGA can be achieved.

Since a plurality of circuits can switchably be implemented to one area by using such a dynamic partial reconfiguration technique, it is possible to time-divisionally multiplex the hardware resources and thus change the function to be achieved in the logic block. As a result, it is possible by few hardware resources to flexibly achieve various functions according to intended purposes while maintaining high operation performance using the hardware.

Besides, an image processing apparatus such as an MFP (multi-function printer) or the like can select a plurality of processes (e.g., a copy job, a print job, a transmission job, etc.) according to user's requests, and achieve an image process according to each of the selected processes by the hardware or the software.

In case of causing the dynamic reconfigurable FPGA to process a part of the image process function in the MFP, the dynamic reconfiguration to the FPGA is performed generally at the timing when the process content is determined by the user's request. After the logic circuit information according to the process content was written into the configuration memory, a series of the processes according to the user's requests can be performed.

Japanese Patent Application Laid-Open No. 2007-179535 discloses that, when a dynamic reconfiguration is performed, a plurality of pieces of logic circuit information respectively having different features are prepared in advance to one process content, and the logic circuit information is selected according to the operation state of a system. Here, as one example of the different feature, a feature of low power consumption is provided. Thus, when performing a desired process, it is possible to achieve the process while reducing the power consumption.

However, Japanese Patent Application Laid-Open No. 2007-179538 is silent about how to reduce power consumption of an FPGA after the end of the desired process. That is, the logic circuit of the FPGA remains configured even after the end of the desired process. In general, in a same frequency, the larger the scale of the configured logic circuit, the larger the scale of a clock tree, so that the power consumption of the FPGA becomes large. Such a phenomenon occurs even in the state that the FPGA is not used. Thus, the power according to the logic circuit corresponding to the desired process is continuously consumed in the state that the FPGA is not used.

### SUMMARY OF THE INVENTION

According to one aspect of the present invention, it is possible to reduce power consumption.

Therefore, the present invention is characterized by an image processing apparatus which comprises: an identifying unit configured to identify a logic circuit according to a job; a selecting unit configured to select configuration data corresponding to the logic circuit identified by the identifying unit; a first transferring unit configured to transfer the configuration data selected by the selecting unit to a dynamic reconfiguration unit; and a second transferring unit configured to, in a case where an image process related to the job in the dynamic reconfiguration unit to which the configuration data was transferred by the first transferring unit is ended, transfer configuration data of a logic circuit of a dummy process, to the dynamic reconfiguration unit.

Further features of the present invention will become apparent from the following description of exemplary embodiments with reference to the attached drawings.

### BRIEF DESCRIPTION OF THE DRAWINGS

FIG. 1 is a block diagram illustrating an example of the hardware constitution of an image processing apparatus.

FIG. 2 is a diagram illustrating an example of configuration data of a dynamic reconfiguration unit to be stored in an ROM.

FIGS. 3A and 3B are block diagrams each illustrating an example of the dynamic reconfiguration unit of the first embodiment.

FIG. 4 is a flow chart indicating an example of an information process related to a reconfiguration of the dynamic reconfiguration unit of the first embodiment.

FIG. 5 is a flow chart indicating an example of an information process related to a reconfiguration of the dynamic reconfiguration unit of the second embodiment.

FIG. 6 is a diagram illustrating an example of a list of reserved jobs.

FIG. 7 is a flow chart indicating an example of an information process related to a reconfiguration of the dynamic reconfiguration unit of the third embodiment.

FIG. 8 is a diagram illustrating an example of a table on which information related to the configuration data has been described.

FIGS. 9A and 9B are block diagrams each illustrating an example of the dynamic reconfiguration unit of the fourth embodiment.

FIG. 10 is a flow chart indicating an example of an information process related to a reconfiguration of the dynamic reconfiguration unit of the fourth embodiment.

FIG. 11 is a diagram illustrating an example of the dynamic reconfiguration unit of the fifth embodiment.

FIG. 12 is a flow chart indicating an example of an information process related to a reconfiguration of the dynamic reconfiguration unit of the fifth embodiment.

### DESCRIPTION OF THE EMBODIMENTS

Preferred embodiments of the present invention will now be described in detail in accordance with the accompanying drawings.

### First Embodiment

Hardware Constitution of Image Processing Apparatus 100

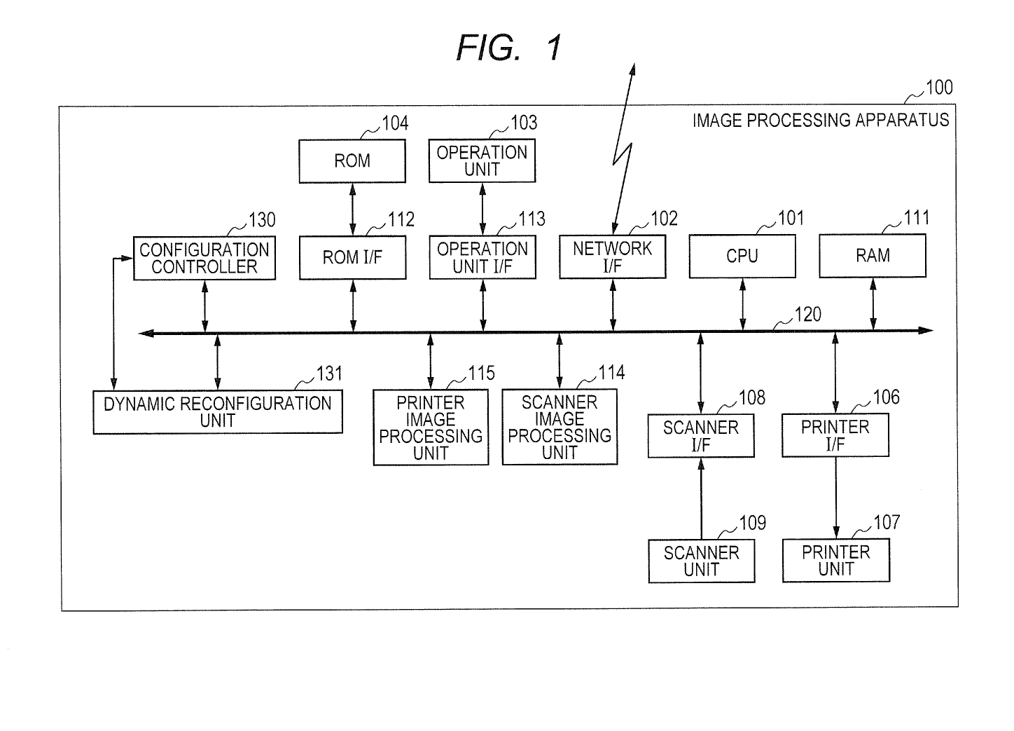

FIG. 1 is a block diagram illustrating an example of the hardware constitution of an image processing apparatus 100. In the present embodiment, the image processing apparatus 100 comprises an operation unit 103 by which a user using the image processing apparatus 100 performs various operations, a scanner unit 109 which reads image information in response to an instruction from the operation unit 103, and a printer unit 107 which prints image data on a paper. More specifically, the scanner unit 109 comprises a CPU (central processing unit) for controlling the scanner unit 109, and an illumination lamp and a scan mirror for performing original document reading. The printer unit 107 comprises a CPU for controlling the printer unit 107, a photosensitive drum for performing image formation, and a fixing device for performing image fixing. The operation unit 103 comprises a power saving key. Thus, if the power saving key is depressed, a control signal is input via an operation unit I/F (interface) 113, and thus the power state of the image processing apparatus is transitioned/returned to/from a power saving state.

Moreover, the image processing apparatus 100 comprises a CPU 101 for totally controlling the operations of the image processing apparatus 100. Namely, the CPU 101 executes control programs for controlling the respective functional blocks of the image processing apparatus.

Moreover, the image processing apparatus 100 comprises a ROM 104 in which a boot program to be executed by the CPU 101, and logic circuit configuration information for configuring a dynamic reconfiguration unit 131 to be implemented in an FPGA or the like have been stored. Moreover, the image processing apparatus 100 comprises a RAM (random access memory) 111. Here, the RAM 111 functions as a system working memory which is necessary for the CPU 101 to operate, functions as an image memory in which image data is temporarily stored, and functions a memory which is used to duplicate, store and read at high speed the logic circuit configuration information stored in the ROM 104.

Moreover, the image processing apparatus 100 comprises a scanner image processing unit 114 and a printer image processing unit 115. The scanner image processing unit 114 performs various image processes such as correction, processing, editing and the like to the image data read by the scanner unit 109. The printer image processing unit 115 performs image processes such as correction and the like to the image data to be print output, in accordance with the state and property of the printer unit 107.

Moreover, the image processing apparatus 100 comprises the dynamic reconfiguration unit 131, and a configuration controller 130 which controls the circuit configuration of the dynamic reconfiguration unit. The circuit configuration of the dynamic reconfiguration unit 131 can be dynamically rewritten. In the dynamic reconfiguration unit 131, a logic circuit for performing various image processes in response to requests from a user is provided. Moreover, the image processing apparatus 100 comprises a scanner I/F 108 to which the image data is input from the scanner unit 109, and a printer I/F 106 which outputs the image data to the printer. Incidentally, the logic circuit provided in the dynamic reconfiguration unit 131, the scanner image processing unit 114, the printer image processing unit 115, the scanner I/F 108 and the printer I/F 106 are respectively connected to a system bus 120 capable of transferring the image data processed.

Moreover, the image processing apparatus 100 performs communication (transmission/reception) with a general-purpose computer provided on a network via a network I/F 102. The image processing apparatus 100 comprises a ROM I/F 112. The ROM I/F 112 controls the boot program to be executed by the CPU 101, and data writing/reading operations to/from the ROM 104 in which the logic circuit configuration information (configuration data) for configuring the dynamic reconfiguration unit 131 has been stored. Moreover, the image processing apparatus 100 comprises the system bus 120 by which the CPU 101, the network I/F 102, the operation unit 103, the ROM I/F 112, the configuration controller 130 and the dynamic reconfiguration unit 131 are mutually connected to others. The CPU 101 performs parameter setting for the processing unit configured in the dynamic reconfiguration unit 131, the scanner image processing unit 114 and the printer image processing unit 115, via the system bus 120.

Incidentally, it should be noted that later-described functions of the image processing apparatus 100 and processes in later-described flow charts are achieved on the premise that the CPU 101 performs various processes based on programs stored in the ROM 104 and the like.

Example of Image Processing Circuit Configured in Dynamic Reconfiguration Unit 131

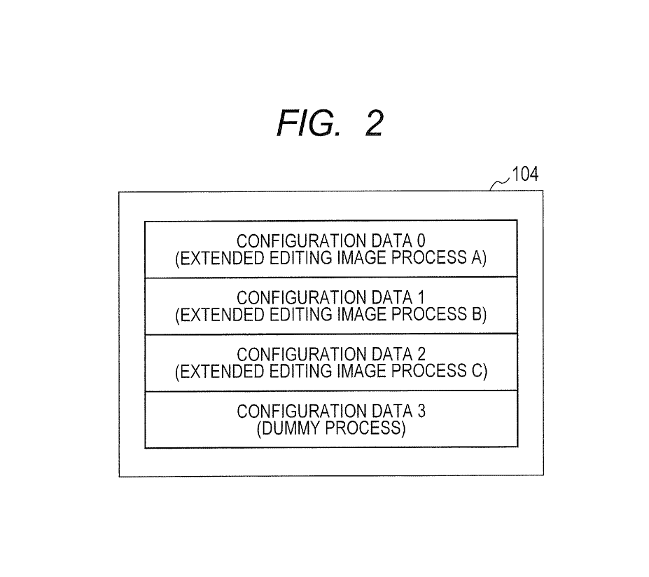

Subsequently, an example of the image processing circuit configured in the dynamic reconfiguration unit 131 of the image processing apparatus will be described with reference to FIG. 2.

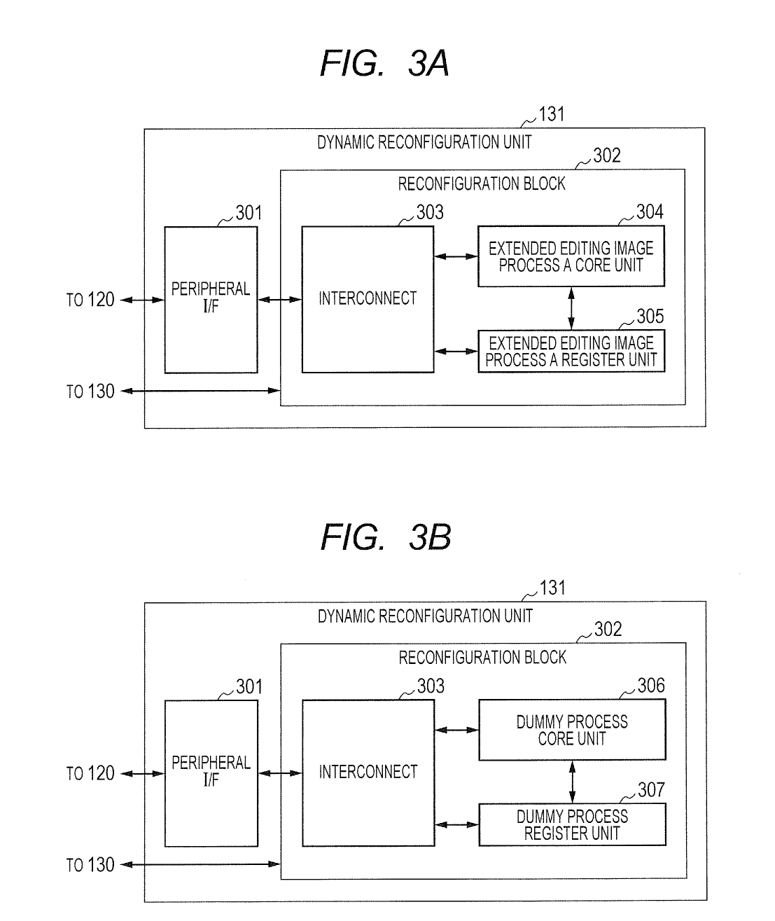

That is, FIG. 2 is the diagram illustrating an example of configuration data of the dynamic reconfiguration unit 131 to be stored in the ROM 104. As illustrated in FIG. 2, the plurality of configuration data have been stored in the ROM 104. More specifically, configuration data 0 to 2 respectively correspond to the logic circuits of extended editing image processes A to C, and configuration data 3 corresponds to the logic circuit of a dummy process. The logic circuit of the dummy process will be described later with reference to FIG. 3B.

Each of the logic circuits of the extended editing image processes A to C is, for example, a logic circuit of the image process related to image editing such as image magnification change, image synthesis and the like for conforming an image to a layout required by a user.

FIG. 3A is a block diagram exemplarily illustrating a case where the extended editing image process A is configured in the dynamic reconfiguration unit 131. The dynamic reconfiguration unit 131 comprises a peripheral I/F 301 and a reconfiguration block 302. The peripheral I/F 301 is an I/F unit to be used when the FPGA or the like performs communication with another LSI (large-scale integration), and the peripheral I/F is implemented by a standard such as the PCI-Express (Peripheral Component Interconnect Express) or the like. Incidentally, the peripheral I/F 301 is the logic circuit which has been embedded and configured in the FPGA or the like, and is a portion which cannot be reconfigured. The reconfiguration block 302 is a portion which can be dynamically reconfigured in the dynamic reconfiguration unit 131. The logic circuit of each configuration data is configured in the reconfiguration block 302. In FIG. 3A, the reconfiguration block 302 comprises an interconnect 303, an extended editing image process A core unit 304 and an extended editing image process A register unit 305. The interconnect 303 is an interconnect circuit which comprises a bus bridge for enabling mutual connection among the Peripheral I/F 301, the extended editing image process A core unit 304 and the extended editing image process A register unit 305. The extended editing image process A core unit 304, which is a logic circuit of the extended editing image process A, performs image data transmission/reception to/from the interconnect 303, and transmits/receives the set value related to the image process to/from the extended editing image process A register unit 305. The extended editing image process A register unit 305 internally stores the set value received from the interconnect 303 and related to the image process performed by the extended editing image process A core unit 304, and transmits the set value to the extended editing image process A core unit 304.

The configuration of the extended editing image process A has been described as above. Here, since the extended editing image processes B and C can be implemented by the same configuration as above, the description of the configurations thereof will be omitted. Incidentally, although it has been described in the present embodiment that the extended editing image processes A to C are configured in the dynamic reconfiguration unit 131, such configurations are merely one example. That is, any image process may be configured according to a job or the like.

Subsequently, an example of the logic circuit of the dummy process in the present embodiment will be described. FIG. 3B is the block diagram illustrating the example of the logic circuit of the dummy process. In the present embodiment, when the logic circuit is configured and maintained in the dynamic reconfiguration unit 131, the power consumption of the logic circuit of the dummy process is smaller than that of each of other logic circuits (the logic circuits of the extended editing image processes A, B and C). The configuration data for configuring the logic circuit of the dummy process can be obtained also by, for example, outputting the configuration data in a UI (user interface) of an application of generating the configuration data without arranging a logic circuit. Incidentally, in FIG. 3B, the same reference numerals as those in FIG. 3A are added to the same blocks as those in FIG. 3A, and the descriptions of the blocks same as those already described will be omitted. The logic circuit of the dummy process is configured in the reconfiguration block 302. The reconfiguration block 302 comprises the interconnect 303, a dummy process core unit 306 and a dummy process register unit 307. The dummy process core unit 306 does not provide a logic of the image process but provides only a connecting process logic in regard to the interconnect 303. Namely, the circuit scale of the dummy process core unit is very small. As an example of connecting process logic, there is a circuit which performs bus control so as to not lock the bus in regard to a bus request from the interconnect 303, discards received data internally, and transmits predetermined fixed data. The dummy process register unit 307 provides only the connecting process logic in regard to the interconnect 303. Also the circuit scale of the dummy process register unit is very small. Incidentally, in the present embodiment, the logic circuit of the dummy process is merely an example. Namely, it is possible to adopt another configuration. As an example, the reconfiguration block 302 may provide only the connecting process logic in regard to the peripheral I/F 301. As another example, the reconfiguration block 302 may be a small-scale logic circuit which holds writing request data from the peripheral I/F 301, and returns the held data in response to a reading request from the peripheral I/F 301. As still another example, the reconfiguration block 302 may comprise only a register unit. If only the register unit is provided, the circuit scale is generally small. As still another example, the dummy process core unit 306 provided in the reconfiguration block 302 may comprise an image process logic of which the power consumption is very small as compared with the above core unit of another extended editing image process. As still another example, instead of the logic circuit of the dummy process, the dummy process core unit 306 may be set to a blank state corresponding to the state immediately after Power-on of the FPGA. For example, the blank state corresponds to the state in which the content of an LUT (look-up table) of an SRAM (static random access memory) for determining the logic circuit of the FPGA has been initialized immediately after power-on.

Information Process Related to Reconfiguration of Dynamic Reconfiguration Unit 131

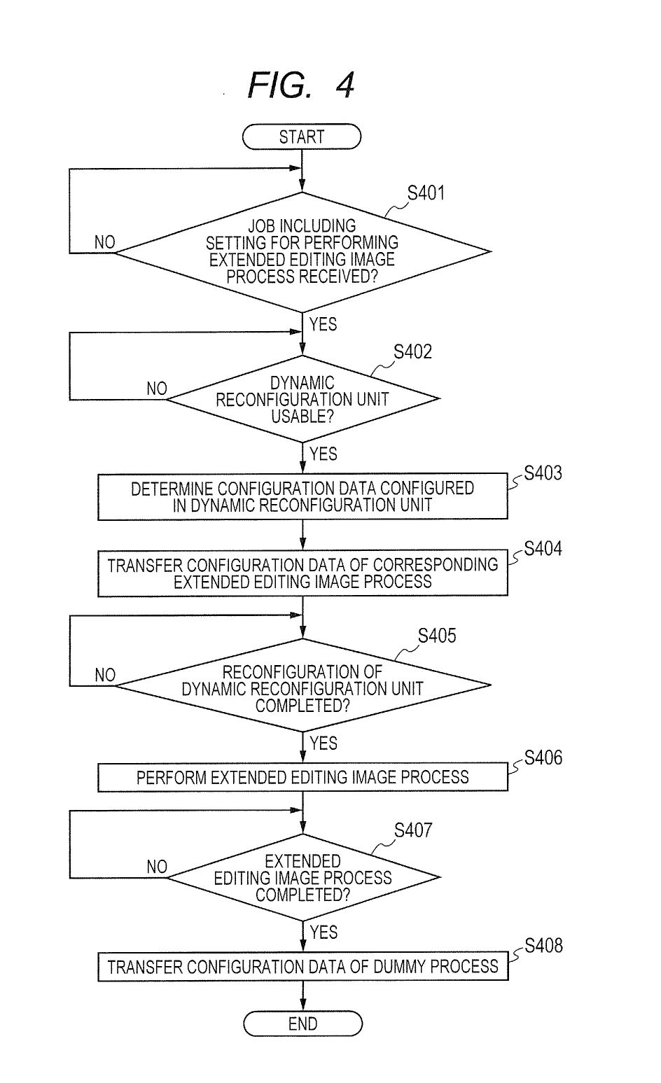

Subsequently, an information process related to the reconfiguration of the dynamic reconfiguration unit 131 in the image processing apparatus 100 according to the present embodiment will be described with reference to FIG. 4.

In S401, the CPU 101 decides whether or not a job including setting information for performing the extended editing image process is received. In this step, it is important to check whether or not it is necessary to use the dynamic reconfiguration unit 131 for performing the job. In the present embodiment, it has been set in the setting information or the like to perform the extended editing image process in the dynamic reconfiguration unit 131. For this reason, the CPU 101 decides whether or not the received job includes the setting information for performing the extended editing image process. If it is decided by the CPU 101 that the job including setting information for performing the extended editing image process is received, the process is advanced to S402.

In S402, the CPU 101 decides whether or not the dynamic reconfiguration unit 131 is usable. For example, the CPU 101 decides that the dynamic reconfiguration unit 131 is not usable when the dynamic reconfiguration unit 131 is being used in another job, and waits for the operation until the dynamic reconfiguration unit becomes usable. If it is decided by the CPU 101 that the dynamic reconfiguration unit 131 is usable, the process is advanced to S403. For example, the CPU 101 decides whether or not the dynamic reconfiguration unit 131 is being used in another job, based on a table showing the used states or the like of the dynamic reconfiguration unit 131. More specifically, when the dynamic reconfiguration unit 131 is being used in a certain job, the CPU 101 sets on the table the information indicating that the dynamic reconfiguration unit is being used. Then, when the use of the dynamic reconfiguration unit is ended, the CPU sets on the table the information indicating that the dynamic reconfiguration unit is not used.

In S403, the CPU 101 determines the configuration data to be configured in the dynamic reconfiguration unit 131 according to the setting information for performing the extended editing image process of the received job. For example, if the setting information for performing the extended editing image process A exists in the received job, the CPU 101 determines to use the configuration data 0 from among the configuration data illustrated in FIG. 2. In S404, the CPU 101 transfers the configuration data to be stored in the ROM 104 to the dynamic reconfiguration unit 131 via the configuration controller. Thus, the dynamic reconfiguration unit 131 has the configuration according to the transferred configuration data. Incidentally, the configuration data transferred by the CPU 101 is the data properly selected from the configuration data 0 to 2 according to the setting information for performing the extended editing image process of the received job.

In S405, the CPU 101 decides whether or not the reconfiguration of the dynamic reconfiguration unit 131 is completed by the configuration data transferred to the dynamic reconfiguration unit 131. For example, the CPU 101 can decide the completion of the reconfiguration by monitoring a reconfiguration completion signal from the dynamic reconfiguration unit 131. If it is decided by the CPU 101 that the reconfiguration of the dynamic reconfiguration unit 131 is completed, the process is advanced to S406.

In S406, the CPU 101 transfers the image data stored in the RAM 111 to the dynamic reconfiguration unit 131, and performs the extended editing image process requested by a user. Then, the image data subjected to the extended editing image process is again stored in the RAM 111. Incidentally, the present embodiment premises that the image data has already been stored in the RAM 111. Namely, before the process of this step, the CPU 101 obtains the image data by an input method according to the job, and stores the obtained image data in the RAM 111. For example, in a copy job, the CPU 101 controls the scanner unit 109 to read a paper original document, and obtains the read and digitized image data from the read document. The CPU 101 controls the scanner image processing unit 114 to process the obtained image data via the scanner I/F 108, and then store the processed image data in the RAM 111.

in S407, the CPU 101 decides whether or not the extended editing image process performed in the dynamic reconfiguration unit 131 is completed. For example, the CPU 101 may transmit an inquiry signal to the dynamic reconfiguration unit 131, and decide whether or not the extended editing image process is completed in response to a reply signal of the inquiry signal. Moreover, for example, the CPU 101 may wait for a signal indicating the end of the process from the dynamic reconfiguration unit 131, and decide whether or not the extended editing image process completed according to whether or not the relevant signal is received. If it is decided by the CPU 101 that the extended editing image process is completed, the process is advanced to S408.

In S408, the CPU 101 transfers the configuration data 3 of the logic circuit of the dummy process stored in the ROM 104 to the dynamic reconfiguration unit 131 via the configuration controller. Thus, in the dynamic reconfiguration unit 131, the logic circuit of the dummy process of the transferred configuration data 3 is configured. It should be noted that the logic circuit of the dummy process has been described as above.

As described above, in the present embodiment, the dynamic reconfiguration unit 131 is reconfigured to the dummy process circuit at the stage that the use of the logic circuit of the image process configured in the dynamic reconfiguration unit 131 is ended. Thus, when the dynamic reconfiguration unit 131 is not used, the configured logic circuit is remarkably smaller than the logic circuit of the image process. As described above, in the dynamic reconfiguration unit 131 implemented by the FPGA or the like, generally, the smaller the circuit scale of the logic circuit, the smaller the power to be consumed. Therefore, by the information process related to the reconfiguration of the dynamic reconfiguration unit 131 in the present embodiment, it is possible to reduce the total power to be consumed in the dynamic reconfiguration unit 131.

Here, the CPU 101 may turn on and off the power supply of the dynamic reconfiguration unit 131 in S408. In this case, when the dynamic reconfiguration unit 131 is started, the CPU 101 may select the configuration data of the logic circuit of the dummy process, and transfer the selected configuration data to the dynamic reconfiguration unit 131.

### Second Embodiment

In the first embodiment, the dynamic reconfiguration unit 131 is reconfigured to the logic circuit of the dummy process circuit at the stage that the use of the logic circuit of the image process configured in the dynamic reconfiguration unit 131 is ended. However, the power to be consumed in the dynamic reconfiguration is generally large. Therefore, only by the control of the CPU 101 to merely reconfigure the dynamic reconfiguration unit to the logic circuit of the dummy process when the use of the logic circuit of the image process is ended, there is a Possibility that the total power consumption is large. For example, when both the successive jobs performed by the image processing apparatus 100 use the dynamic reconfiguration unit 131, it is supposed that, even when the dynamic reconfiguration unit is reconfigured to the logic circuit of the dummy process, the obtained logic circuit is immediately reconfigured again to the logic circuit of the image process by the subsequent job. In this case, not performing the reconfiguration to the logic circuit of the dummy process can reduce the total power consumption. Such a circumstance is considered in the second embodiment. That is, in the present embodiment, the CPU 101 decides whether or not there is a use schedule of the dynamic reconfiguration unit 131 at the stage that the use of the logic circuit of the image process configured in the dynamic reconfiguration unit 131 is ended, and controls the reconfiguration to the logic circuit of the dummy process according to the decided result. Incidentally, since the constitution of the image processing apparatus 100 and the configuration of the logic circuit of the image process of the dynamic reconfiguration unit 131 are the same as those described in the first embodiment, the descriptions thereof will be omitted in the present embodiment.

Information Process Related to Reconfiguration to Dynamic Reconfiguration Unit 131

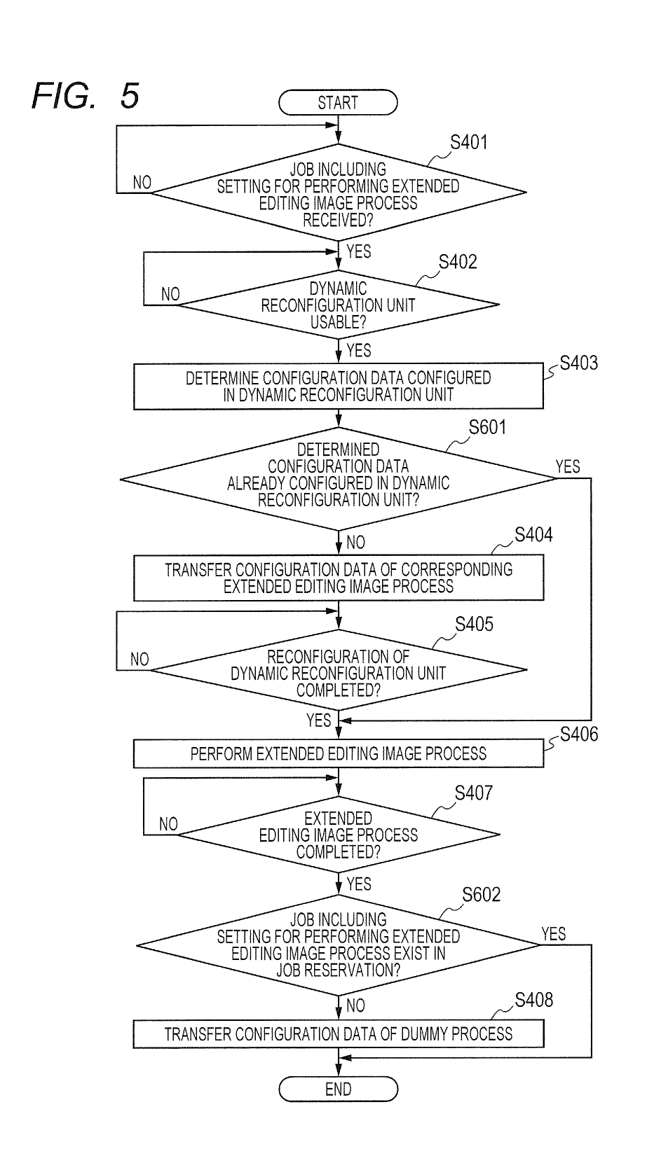

An information process related to the reconfiguration to the dynamic reconfiguration unit 131 in the image processing apparatus 100 according to the present embodiment will be described with reference to FIG. 5.

Incidentally, the descriptions of the processes same as those (S401 to S408) described in the first embodiment will be omitted, and only the processes (S601 and S602) added in the present embodiment will be described hereinafter.

In S601, the CPU 101 decides whether or not the configuration data determined in S403 has already been configured in the dynamic reconfiguration unit 131. For example, the CPU 101 prepares in advance the information for managing the configuration data configured in the dynamic reconfiguration unit 131, and performs the above decision based on the prepared information. The CPU 101 may write the number or the like of the used configuration data in a predetermined memory space or the like, whenever performing the reconfiguration of the dynamic reconfiguration unit 131. In any case, if it is decided by the CPU 101 that the determined configuration data has already been configured in the dynamic reconfiguration unit 131, the process is advanced to S406. On the other hand, if it is decided by the CPU 101 that the determined configuration data has not been configured in the dynamic reconfiguration unit 131, the process is advanced to S404. By the above deciding process, when the desired configuration data has already been configured in the dynamic reconfiguration unit 131, since the reconfiguration process (S404 and S405) of the dynamic reconfiguration unit 131 is not performed, the overall processing time can be shortened. In addition, the loads of the respective processing units such as the CPU 101 and the like can be reduced.

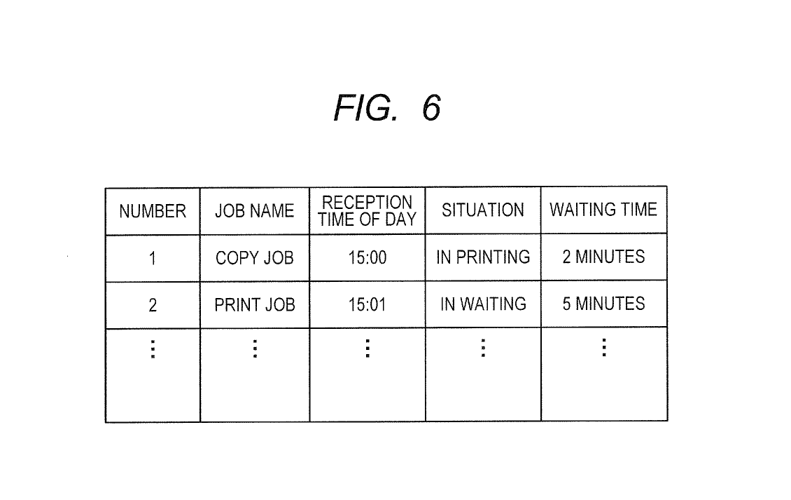

In S602, the CPU 101 decides whether or not the job including the setting information for performing the extended editing image process exists in the jobs reserved to be performed by the image processing apparatus 100 (i.e., job reservation). The process in S602 is an example of a reservation deciding process of deciding whether or not the job in which the same image process as the image process such as the extended editing image process or the like is performed exists in the plurality of reserved jobs. Here, the reserved job is the job which is not yet performed and is waiting to be performed, among the jobs entered in the image processing apparatus 100. An example of the job list of the reserved jobs is illustrated in FIG. 6. For example, the copy job of the number “1” is the job which is currently in printing, and the print job of the number “2” is the job which is in waiting because the most-recent copy job is currently in printing. Therefore, in the example of FIG. 6, the reserved job is the print job of the number “2”. If the reserved job is identified, the CPU 101 refers to the detailed job setting information of each job. Thus, the CPU 101 can decide whether or not the job including the setting information for performing the extended editing image process exists in the reserved jobs. Then, if it is decided by the CPU 101 that the job including the setting information for performing the extended editing image process does not exist in the reserved jobs, the process is advanced to S408. On the other hand, if it is decided by the CPU 101 that the job including the setting information for performing the extended editing image process exists in the reserved jobs, the process of this flow chart is ended.

Incidentally, although the image process to be performed by the dynamic reconfiguration unit 131 is the extended editing image process in the present embodiment, the image process is not limited to the extended editing image process. The point is that the CPU 101 decides whether or not the job in question is the lob using the dynamic reconfiguration unit 131. Besides, although the number of the reserved job is “1” in the present embodiment, two or more jobs may be reserved. In this case, the CPU 101 performs the above deciding process to all the reserved jobs.

As described above, in the present embodiment, it is further decided whether or not there is the use schedule of the dynamic reconfiguration unit 131 at the stage that the use of the logic circuit of the image process configured to the dynamic reconfiguration unit 131 is ended, and the reconfiguration is performed to the logic circuit of the dummy process according to the decided result. Further, if the use schedule cannot be decided, the CPU 101 measures the time during which the dynamic reconfiguration unit 131 is not used, and decides whether or not the measured time is equal to or longer than a set time. This process is an example of a time deciding process. Then, the CPU 101 may perform the reconfiguration to the logic circuit of the dummy process when the measured time becomes equal to or longer than the set time. By the information process related to the reconfiguration to the dynamic reconfiguration unit 13 according to the present embodiment, it is possible to eliminate the power consumption due to useless dynamic reconfiguration. Thus, it is possible to reduce the total power consumed in the dynamic reconfiguration unit 131.

### Third Embodiment

In the first and second embodiments, the power consumption is reduced by reconfiguring the logic circuit of the dummy process to the dynamic reconfiguration unit 131. However, if the circuit scale of the logic circuit of the image process configured in the dynamic reconfiguration unit 131 is originally small, power consumption reduction effect obtained in case of performing the reconfiguration to the logic circuit of the dummy process is small, and large power for the dynamic reconfiguration is consumed. To surely reduce the total power consumption, the reconfiguration should be performed only in a case where the power consumption reduction effect obtained in case of Performing the reconfiguration to the logic circuit of the dummy process is large. In the third embodiment, in consideration of such situations as described above, an example of the process by the CPU 101 will be described. That is, at the stage that the use of the logic circuit of the image process configured in the dynamic reconfiguration unit 131 is ended, the CPU 101 further decides whether or not the circuit scale of the logic circuit of the image process configured in the dynamic reconfiguration unit 131 is equal to or larger than a set size. Then, the CPU 101 controls the reconfiguration to the logic circuit of the dummy process according to the decided result. Incidentally, in the present embodiment, the circuit scale of the logic circuit will be described as a used amount (percentage) of the reconfigurable resources previously provided in the dynamic reconfiguration unit 131. Besides, since the constitution of the image processing apparatus 100 and the configuration of the logic circuit of the image process of the dynamic reconfiguration unit 131 are the same as those described in the first embodiment, the descriptions thereof will be omitted in the present embodiment.

Information Process Related to Reconfiguration to Dynamic Reconfiguration Unit 131

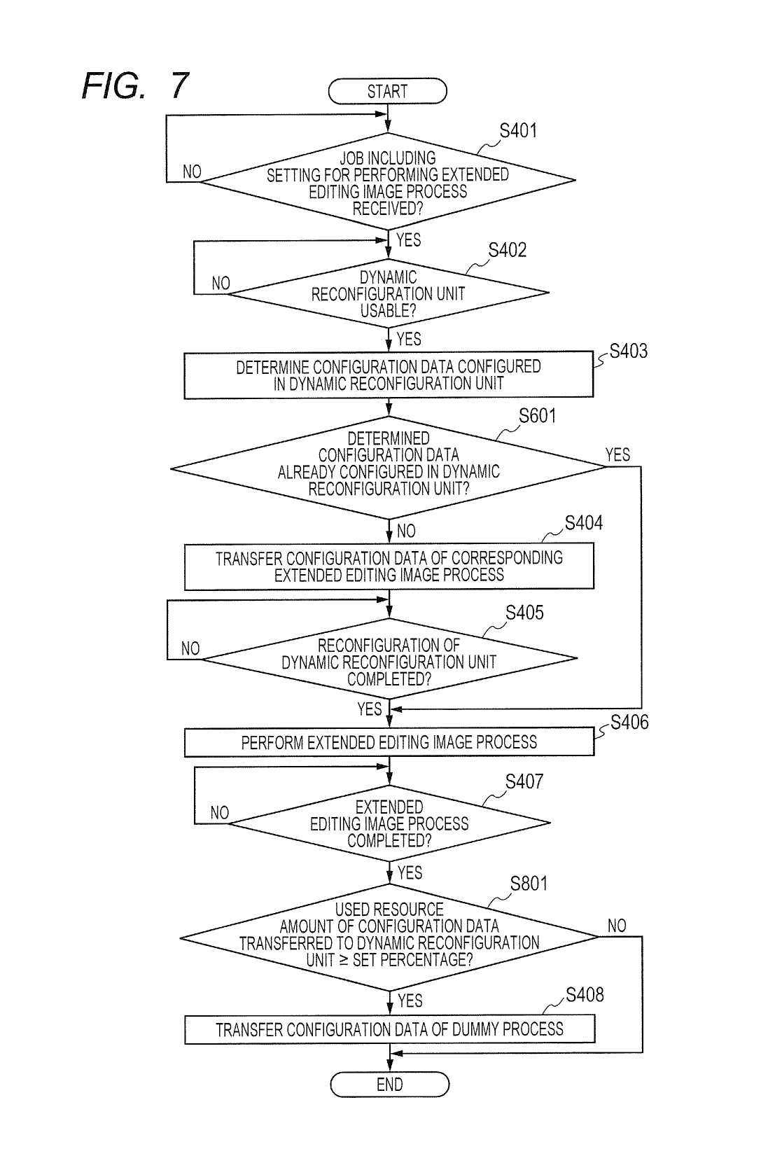

An information process related to the reconfiguration to the dynamic reconfiguration unit 131 of the image processing apparatus 100 in the present embodiment will be described with reference to FIG. 7.

Incidentally, the descriptions of the processes same as those (S401 to S408, and S601) described in the first and second embodiments will be omitted, and only the process (S801) added in the present embodiment will be described hereinafter.

In S801, the CPU 101 decides whether or not the used resource amount of the configuration data transferred in S404 in the dynamic reconfiguration unit 131 is equal to or higher than a set percentage. If it is decided by the CPU 101 that the used resource amount is equal to or higher than the set percentage, the process advanced to S408. On the other hand, if it is decided by the CPU 101 that the used resource amount is not equal to or higher than the set percentage, the process of this flow chart is ended. Here, the value of the set percentage may be previously held in the ROM 104 or the like, or may be set or changed by the CPU 101 according to the operation via the operation unit 103 or the like. The process in S801 is an example of a used resource amount deciding process.

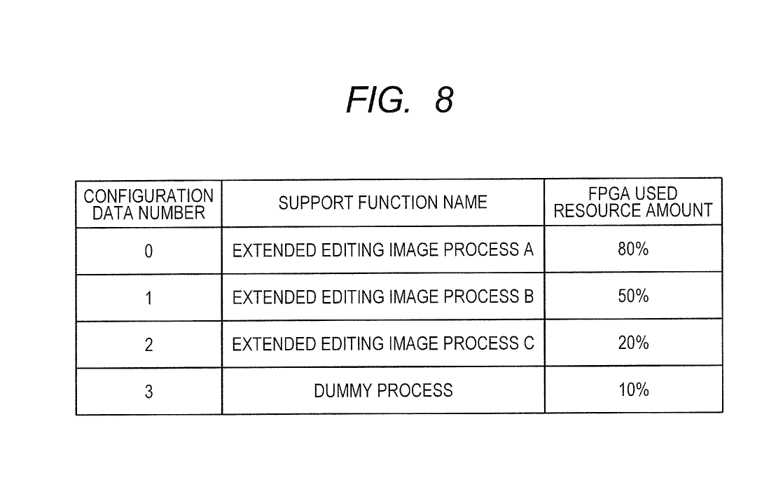

Hereinafter, the process to be performed in S801 will further be described in detail. For the process in S801, it is necessary to previously prepare a table as illustrated in FIG. 8 on which the information related to each configuration data has been described. Since the used resource amount can be obtained from the number of the configuration data transferred in S404, the CPU 101 can decide whether or not the used resource amount is equal to or higher than the set percentage. Incidentally, the used resource amount is equivalent to the percentage indicating, in the resources previously provided in the FPGA, how much the resources are used when synthesizing an RTL (register-transfer level) of the logic circuit of each image process for the dynamic reconfiguration unit 131. For example, it is assumed that the threshold is set to 21%. In this case, if the configuration data numbers are “0” and “1”, the CPU 101 decides that the used resource amount in the dynamic reconfiguration unit 131 is equal to or higher than the set percentage. On the other hand, if the configuration data number is “2”, the CPU 101 decides that the used resource amount in the dynamic reconfiguration unit 131 is not equal to or higher than the set percentage. Incidentally, it is impossible to uniquely define the threshold because it depends on the system to which the dynamic reconfiguration unit 131 is applied and the implementation of the dynamic reconfiguration unit 131. However, for example, it is possible to first determine to what extent the power consumption of the dynamic reconfiguration unit 131 should be suppressed when the dynamic reconfiguration unit 131 is not operated, and then set the used resource amount equivalent to the border of the suppression as the threshold. To achieve such setting, for example, it is necessary to set the threshold in the ROM 104 or the like by estimating in advance the power consumption of the logic circuit corresponding to each configuration data.

As described above, in the present embodiment, at the stage that the use of the logic circuit of the image process configured to the dynamic reconfiguration unit 131 is ended, the CPU 101 further performs the following processes. That is, the CPU 101 decides whether or not the circuit scale of the logic circuit of the image process configured in the dynamic reconfiguration unit 131 is equal to or larger than the set size, and performs the reconfiguration to the logic circuit of the dummy process according to the decided result. Thus, since the reconfiguration to the logic circuit of the dummy process is performed only when the power consumption reduction effect is large, a wasteful dynamic reconfiguration can be prevented. Therefore, it is possible to reduce the total power consumed in the dynamic reconfiguration unit 131. Incidentally, in the present embodiment, the CPU 101 performs the decision based on the circuit scale in S801. However, if the power consumption of the logic circuits corresponding to all the configuration data has been estimated, the CPU 101 may perform the decision based on the power estimation value of each configuration data. That is, as illustrated in FIG. 8, if the power consumption amounts of the dynamic reconfiguration unit 131 have respectively been set by the percentages in correspondence with the numbers of the configuration data and the like, the CPU 101 decides whether or not the power consumption amount of the dynamic reconfiguration unit 131 related to the configuration data is equal to or larger than the set percentage. This process an example of a power consumption amount deciding process. In any case, if it is decided that the power consumption amount of the dynamic reconfiguration unit 131 related to the configuration data is equal to or larger than the set percentage, the CPU 101 selects the configuration data of the logic circuit of the dummy process, and transfers the selected configuration data to the dynamic reconfiguration unit 131.

### Fourth Embodiment

The first to third embodiments premise that the reconfiguration can be performed only to the whole chip of the dynamic reconfiguration unit 131. However, as described above, the FPGA or the like in which dynamic partial reconfiguration can be performed has been developed recently. Also, the dynamic reconfiguration unit 131 in which the dynamic partial reconfiguration can be performed can be used. In the fourth embodiment, an example of the dynamic reconfiguration unit 131 in which the dynamic partial reconfiguration can be performed will be described. Incidentally, the descriptions of the blocks same as those already described in the above embodiments will be omitted in the present embodiment.

Constitution of Image Processing Apparatus 100

The hardware constitution of the image processing apparatus 100 is basically the same as that already described in the first embodiment. However, it should be noted that the dynamic partial reconfiguration can be performed for the dynamic reconfiguration unit 131 in the present embodiment.

Configuration of Logic Circuit of Image Process Configured in Dynamic Reconfiguration Unit 131

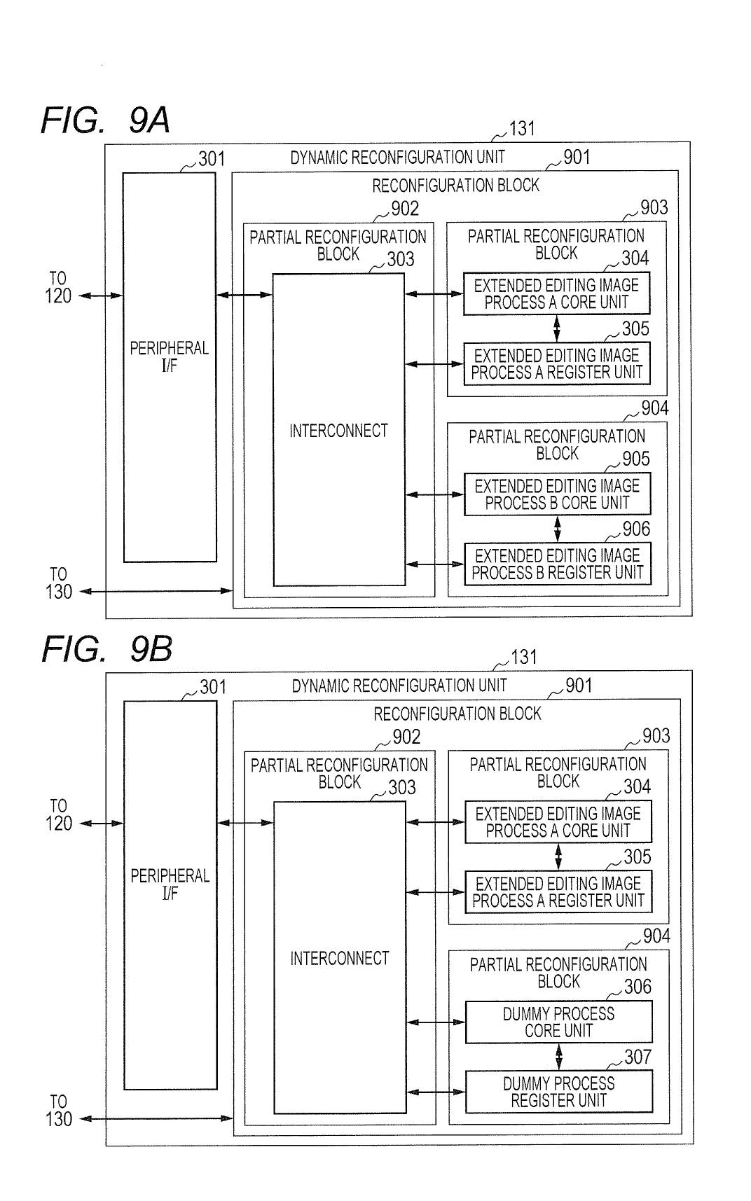

Hereinafter, examples of the logic circuit of the image process configured in the dynamic reconfiguration unit 131 of the image processing apparatus 100 will be described with reference to FIGS. 9A and 9B.

That is, FIG. 9A is the block diagram exemplarily illustrating a case where the logic circuit of the extended editing image process A and the logic circuit of the extended editing image process B are configured in the dynamic reconfiguration unit 131. The dynamic reconfiguration unit 131 comprises the peripheral I/F 301 and a reconfiguration block 901. The constitution of the peripheral I/F 301 is equivalent to that already described in the first embodiment. The reconfiguration block 901 is a dynamic reconfigurable portion in the dynamic reconfiguration unit 131. The reconfiguration block 901 comprises partial reconfiguration blocks 902 to 904 as partially reconfigurable blocks. Each of the partial reconfiguration blocks 902 to 904 can be reconfigured independently when the own block is not operated, even if other partial reconfiguration blocks are being operated.

In FIG. 9A, the partial reconfiguration block 902 comprises the interconnect 303. The interconnect 303 comprises the bus bridge for enabling mutual connection among the peripheral I/F 301, the extended editing image process A core unit 304, the extended editing image process A register unit 305, an extended editing image process B core unit 905 and an extended editing image process B register unit 906. The partial reconfiguration block 903 comprises the extended editing image process A core unit 304 and the extended editing image process A register unit 305. The partial reconfiguration block 904 comprises the extended editing image process B core unit 905 and the extended editing image process B register unit 906.

Incidentally, the circuit constitution of the dynamic reconfiguration unit 131 in the present embodiment is an example which does not limit the present invention. In the present embodiment, one image process function is configured (or provided) to one partial reconfiguration block. However, one image process function may be configured to two partial reconfiguration blocks, or a plurality of image process functions may be configured to one partial reconfiguration block. Besides, in the present embodiment, the number of the blocks in which the dynamic partial reconfiguration can be performed is “3” in the dynamic reconfiguration unit 131. However, the present invention is not limited to this.

FIG. 9B is the block diagram exemplarily illustrating a case where the logic circuit of the extended editing image process A and the logic circuit of the dummy process are configured in the dynamic reconfiguration unit 131. Here, only the configuration of the partial reconfiguration block 904 is different from that illustrated in FIG. 9A. In FIG. 9B, the extended editing image process B core unit 905 and the extended editing image process B register unit 906 configured in the partial reconfiguration block 904 have been replaced by the dummy process core unit 306 and the dummy process register unit 307, respectively. Incidentally, since the dummy process core unit 306 and the dummy process register unit 307 in the logic circuit of the dummy process have already been described as above, the descriptions thereof will be omitted.

Information Process Related to Reconfiguration to Dynamic Reconfiguration Unit 131

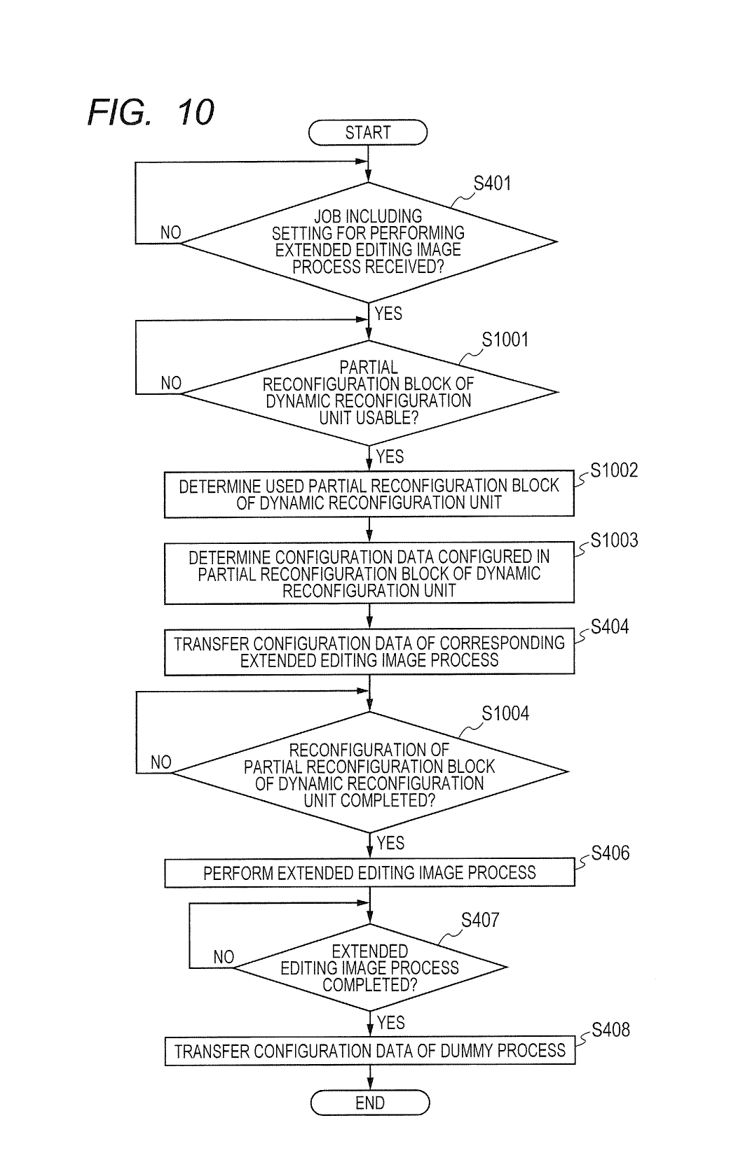

An information process related to the reconfiguration to the dynamic reconfiguration unit 131 in the image processing apparatus 100 will be described with reference to FIG. 10. Incidentally, to simplify the description, it is assumed that one partial reconfiguration block is necessary to configure one extended editing image process function. However, it should be noted that the present embodiment is not limited by such an assumption.

Incidentally, the descriptions of the processes same as those (S401, S404, and S406 to S408) described in the first embodiment will be omitted, and only the processes (S1001 to S1004) added in the present embodiment will be described hereinafter.

In S1001, the CPU 101 decides whether or not the partial reconfiguration block of the dynamic reconfiguration unit 131 is usable. For the above decision, for example, the CPU 101 creates a table or the like for managing the statuses of the partial reconfiguration block in advance. Then, in regard to the table, the CPU 101 sets the status of the partial reconfiguration block to a used state when starting the use of the partial reconfiguration block concerned, and sets the status of the partial reconfiguration block concerned to an unused state when ending the use of the partial reconfiguration block concerned. The status is an example of used state information.

The CPU 101 can decide whether or not the partial reconfiguration block is being used, by referring to the contents of the table via the above table operation. Thus, if the partial reconfiguration block is not being used, the CPU can decide that the partial reconfiguration block concerned is usable. Then, if it is decided by the CPU 101 that the partial reconfiguration block of the dynamic reconfiguration unit 131 is usable, the process is advanced to S1002. On the other hand, if it is decided that the partial reconfiguration block of the dynamic reconfiguration unit 131 is not usable, the CPU 101 waits until the partial reconfiguration block becomes usable. Incidentally, it is assumed in the present embodiment that the CPU decides that the partial reconfiguration block 904 is usable. However, any partial reconfiguration block may be the usable block

In S1002, the CPU 101 determines the used partial reconfiguration block of the dynamic reconfiguration unit 131. In this case, any partial reconfiguration block may be determined if it is the usable partial reconfiguration block.

in S1003, the CPU 101 determines the configuration data to be used, according to the setting information for performing the extended editing image process of the reserved job and the used partial reconfiguration block determined in S1002. In the present embodiment, since the dynamic partial reconfiguration is performed, it is necessary to use the configuration data generated for the corresponding partial reconfiguration block. In the present embodiment, since the partial reconfiguration block 903 and the partial reconfiguration block 904 are provided as the partial reconfiguration blocks for configuring the logic circuit of the image process, the configuration data “0” to “2” exist for each of the partial reconfiguration block 903 and the partial reconfiguration block 904. Moreover, in the present embodiment, it is assumed that the received job includes the setting information for performing the extended editing image process B, and the partial reconfiguration block 904 is decided as the usable partial reconfiguration block. Therefore, it is decided to use the configuration data “1” for the partial reconfiguration block 904. By transferring the determined configuration data with the CPU 101 in S404, the dynamic reconfiguration unit 131 has the configuration as illustrated in FIG. 9A. Incidentally, the reason why the core and register units of the extended editing image process A are configured in the partial reconfiguration block 903 is that it is supposed that a job different from the job currently processed performs the extended editing image process A.

In S1004, the CPU 101 decides whether or not the partial reconfiguration is completed by the configuration data transferred to the dynamic reconfiguration unit 131. For example, the CPU 101 can decide the completion of the partial reconfiguration by monitoring a partial reconfiguration completion signal from the dynamic reconfiguration unit 131. If it is decided by the CPU 101 that the partial reconfiguration is completed, the process is advanced to S406.

As described above, in the present embodiment, at the stage that the use of the logic circuit of the image process configured to the partial reconfiguration block of the dynamic reconfiguration unit 131 is ended, the used partial reconfiguration block of the dynamic reconfiguration unit 131 is reconfigured to the logic circuit of the dummy process. Thus, it is possible to reduce the power consumption when the partial reconfiguration block of the dynamic reconfiguration unit 131 is not used.

### Fifth Embodiment

In the first to fourth embodiments, when the dynamic reconfiguration unit 131 is not used, the power consumption is reduced by reconfiguring the reconfiguration block of the dynamic reconfiguration unit 131 to the logic circuit of the dummy process. In the fifth embodiment, an example that a register and a signal for dynamically controlling clock supply in regard to the generation source of a clock network formed in the dynamic reconfiguration unit 131 are prepared in advance in each configuration data of the logic circuit of the image process will be described. That is, in the present embodiment, the CPU 101 controls to interrupt the clock supply when the dynamic reconfiguration unit 131 is not used. Incidentally, since the constitution of the image processing apparatus 100 is the same as that already described in the first embodiment, the description thereof will be omitted.

Configuration of Logic Circuit of Image Process Configured in Dynamic Reconfiguration Unit 131

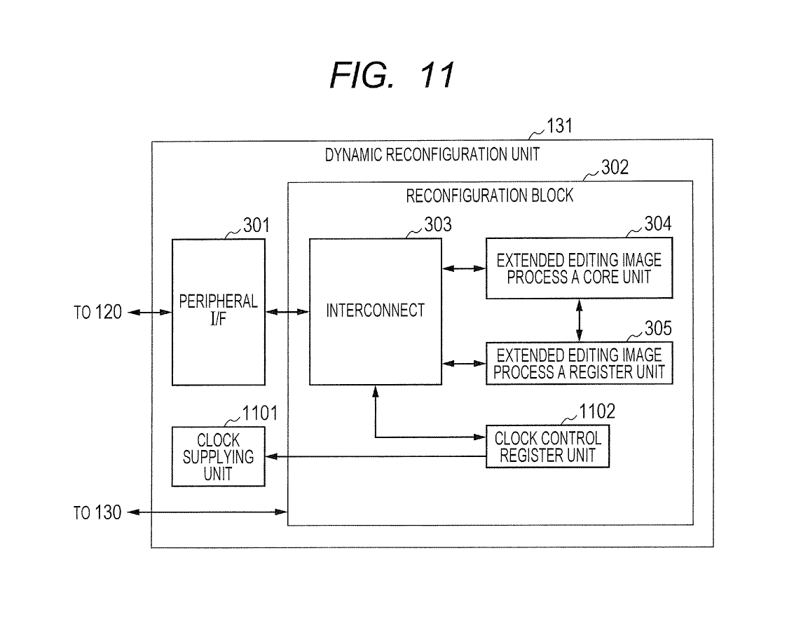

Hereinafter, an example of the logic circuit of the image process configured in the dynamic reconfiguration unit 131 of the image processing apparatus 100 will be described with reference to FIG. 11.

FIG. 11 is the diagram illustrating the example that the logic circuit of the extended editing image process A is configured in the dynamic reconfiguration unit 131. The dynamic reconfiguration unit 131 comprises the peripheral I/F 301, the reconfiguration block 302 and a clock supplying unit 1101. It should be noted that the peripheral I/F 301 has been described as above. The clock supplying unit 1101 is the logic circuit which has been embedded and configured in the FPGA or the like, and is a portion which cannot be reconfigured. However, a signal for controlling interruption of the clock supply can be connected to the clock supplying unit 1101. Such a situation depends on the specification of the FPGA or the like. In FIG. 11, the reconfiguration block 302 comprises the interconnect 303, the extended editing image process A core unit 304, the extended editing image process A register unit 305, and a clock control register unit 1102. The interconnect 303 is an interconnect circuit which is equipped with the bus bridge for enabling mutual connection among the peripheral I/F 301, the extended editing image process A core unit 304, the extended editing image process A register unit 305 and the clock control register unit 1102. It should be noted that the extended editing image process A core unit 304 and the extended editing image process A register unit 305 have already been described as above. The clock control register unit 1102 internally holds the setting value received from the interconnect 303 and related to the interruption of the clock supply to the clock supplying unit 1101, and transmits the setting value to the clock supplying unit 1101. Incidentally, in the present embodiment, it is assumed that the clock supplying unit 1101 interrupts only the clock supply to the extended editing image process A core unit 304 and the extended editing image process A register unit 305 in response to the setting value transferred from the clock control register unit 1102.

Information Process Related to Reconfiguration to Dynamic Reconfiguration Unit 131

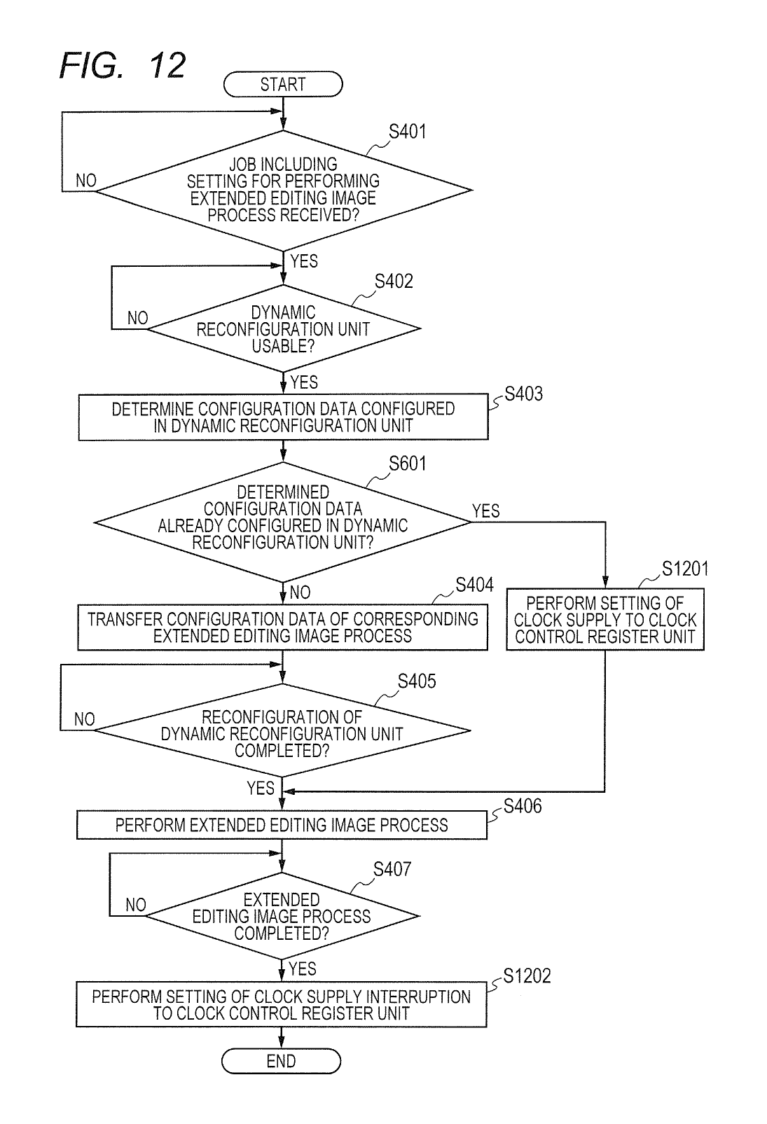

Subsequently, an information process related to the reconfiguration to the dynamic reconfiguration unit 131 of the image processing apparatus 100 according to the present embodiment will be described with reference to FIG. 12.

incidentally, the descriptions of the processes same as those (S401 to S407, and S601) described in the first and second embodiments will be omitted, and only the processes (S1201 to S1202) added in the present embodiment will be described hereinafter.

In S1201, the CPU 101 performs setting of the clock supply from the clock supplying unit 1101 to the clock control register unit 1102 of the logic circuit configured in the dynamic reconfiguration unit 131. This is because, in later S1202, the CPU 101 performs setting of the interruption of the clock supply when the extended editing image process in the dynamic reconfiguration unit 131 is ended. In any case, since the clock is supplied to the logic circuit of the dynamic reconfiguration unit 131 in this step, an operable state is established.

In S1202, the CPU 101 performs the setting to interrupt the clock from the clock supplying unit 1101 to the clock control register unit 1102. Thus, the clock supply from the clock supplying unit 1101 to the extended editing image process A core unit 304 and the extended editing image process A register unit 305 is interrupted.

As described above, in the present embodiment, the clock control register unit 1102 is additionally provided in the logic circuit of the image process configured to the reconfiguration block 302 of the dynamic reconfiguration unit 131. The CPU 101 controls to interrupt the clock supply from the clock supplying unit 1101 via the clock control register unit 1102 at the stage that the use of the dynamic reconfiguration unit 131 is ended. Thus, it is possible to reduce the power consumption when the reconfiguration block 302 of the dynamic reconfiguration unit 131 is not used.

### Other Embodiments

The present invention can also be achieved by a process of supplying the program for achieving one or more functions of the above embodiments to a system or an apparatus via a network or a storage medium and causing one or more processors of the computer of the system or the apparatus to read and execute the supplied program. Besides, the present invention can also be achieved by a circuit (e.g., ASIC) of achieving one or more functions.

Besides, it is possible to carry out the present invention by arbitrarily combining the above embodiments.

As described above, by each of the above embodiments, it is possible to reduce the power consumption.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-166054, filed Aug. 18, 2014, which is hereby incorporated by reference herein in its entirety.

What is claimed is:

1. An image processing apparatus comprising:
an identifying unit configured to identify a logic circuit according to a job;
a selecting unit configured to select configuration data corresponding to the logic circuit identified by the identifying unit;
a first transferring unit configured to transfer the configuration data selected by the selecting unit to a dynamic reconfiguration unit; and
a second transferring unit configured to, in a case where an image process related to the job in the dynamic reconfiguration unit to which the configuration data was transferred by the first transferring unit is ended, transfer configuration data of a logic circuit of a dummy process to the dynamic reconfiguration unit.

2. The image processing apparatus according to claim 1, further comprising a deciding unit configured to decide whether or not the configuration data selected by the selecting unit has already been transferred to the dynamic reconfiguration unit, wherein
in a case where it is decided by the deciding unit that the configuration data has not been transferred to the dynamic reconfiguration unit, the first transferring unit transfers the configuration data to the dynamic reconfiguration unit.

3. The image processing apparatus according to claim 1, further comprising a reservation deciding unit configured to, in a case where the image process related to the job in the dynamic reconfiguration unit to which the configuration data was transferred is ended, decide whether or not a job in which a same image process as the image process is performed exists in a plurality of reserved jobs, wherein
in a case where it is decided by the reservation deciding unit that the job in which the same image process as the image process is performed does not exist in the plurality of reserved jobs, the second transferring unit transfers the configuration data of the logic circuit of the dummy process to the dynamic reconfiguration unit.

4. The image processing apparatus according to claim 1, further comprising a time deciding unit configured to, in the case where the image process related to the job in the dynamic reconfiguration unit to which the configuration data was transferred is ended, decide whether or not a time in which the dynamic reconfiguration unit is not used is equal to or longer than a set time, wherein
in a case where it is decided by the time deciding unit that the time in which the dynamic reconfiguration unit is not used is equal to or longer than the set time, the second transferring unit transfers the configuration data of the logic circuit of the dummy process to the dynamic reconfiguration unit.

5. The image processing apparatus according to claim 1, further comprising a used resource amount deciding unit configured to, in the case where the image process related to the job in the dynamic reconfiguration unit to which the configuration data was transferred is ended, decide whether or not a used resource amount of the dynamic reconfiguration unit related to the configuration data is equal to or higher than a set percentage, wherein
in a case where it is decided by the used resource amount deciding unit that the used resource amount of the dynamic reconfiguration unit related to the configuration data is equal to or higher than the set percentage, the second transferring unit transfers the configuration data of the logic circuit of the dummy process to the dynamic reconfiguration unit.

6. The image processing apparatus according to claim 1, further comprising a power consumption amount deciding unit configured to, in the case where the image process related to the job in the dynamic reconfiguration unit to which the configuration data was transferred is ended, decide whether or not a power consumption amount of the dynamic reconfiguration unit related to the configuration data is equal to or higher than a set percentage, wherein
in a case where it is decided by the power consumption amount deciding unit that the used resource amount of the dynamic reconfiguration unit is equal to or higher than the set percentage, the second transferring unit transfers the configuration data of the logic circuit of the dummy process to the dynamic reconfiguration unit.

7. The image processing apparatus according to claim 1, further comprising a determining unit configured to determine, in a partial reconfiguration unit of the dynamic reconfiguration unit, a partial reconfiguration unit being not used, based on used state information of the partial reconfiguration unit of the dynamic reconfiguration unit, wherein
the selecting unit selects the configuration data corresponding to the logic circuit identified by the identifying unit and the partial reconfiguration unit determined by the determining unit.

8. An image processing apparatus comprising:
an identifying unit configured to identify a logic circuit according to a job;
a selecting unit configured to select configuration data corresponding to the logic circuit identified by the identifying unit;
a transferring unit configured to transfer the configuration data selected by the selecting unit to a dynamic reconfiguration unit; and
a controlling unit configured to, in a case where an image process related to the lob in the dynamic reconfiguration unit to which the configuration data was transferred by the transferring unit is ended, control to interrupt supply of a clock to the logic circuit configured in the dynamic reconfiguration unit.

9. An image processing apparatus comprising:
an identifying unit configured to identify a logic circuit according to a job;
a selecting unit configured to select configuration data corresponding to the logic circuit identified by the identifying unit;
a first transferring unit configured to transfer the configuration data selected by the selecting unit to a dynamic reconfiguration unit; and
a second transferring unit configured to, in a case where a process related to the job in the dynamic reconfiguration unit to which the configuration data was transferred by the first transferring unit is ended, turn off and then on a power supply of the dynamic reconfiguration unit, and transfer configuration data of a logic circuit of a dummy process to the dynamic reconfiguration unit when the dynamic reconfiguration unit is started.
